(19) United States
(12) Patent Application Publication
(10) Pub. No.: US 2004/0215479 A1
(43) Pub. Date: Oct. 28, 2004

(54) Dynamic content electronic mail marketing system and method

(75) Inventors: Scott D. Dorsey, Indianapolis, IN (US); Chris C. Baggott, Greenfield, IN (US); Peter D. McCormick, Minneapolis, MN (US); Sean G. Ryan, Mt. Pleasant, SC (US)

Correspondence Address: Rachel L. St. Peter, ICE MILLER, One American Square, Box 82001, Indianapolis, IN, 46282-0002, US

(73) Assignee: ExactTarget, LLC, Indianapolis, IN

(21) Appl. No.: 10/769,095

(22) Filed: Jan. 30, 2004

Related U.S. Application Data
(60) Provisional application No. 60/444,235, filed on Jan. 31, 2003.

(51) Int. Cl. G06F 17/60

(52) U.S. Cl. 705/1; 705/14

(57) ABSTRACT

A system for the creation of targeted e-mails having dynamic content based on attributes about recipients of the e-mails, and its method of use. The system includes a means for creating an e-mail having a content area designated as dynamic, a means for identifying e-mail recipients having at least one attribute associated therewith, a means for associating the attribute with the dynamic content area, and a means for sending the e-mail to the recipients. The method of use for such system includes the steps of creating an e-mail and designating areas of the e-mail as dynamic so that customized content based on the recipients' attributes can be inserted into such areas, and delivering the e-mail to the recipients.

### CROSS REFERENCE TO RELATED PATENT APPLICATION

This application claims the benefit of U.S. Provisional Application No. 60/444,235 filed on Jan. 31, 2003.

### FIELD OF THE INVENTION

The present invention relates generally to software and marketing systems. More specifically, the present invention relates to a World Wide Web based electronic mail (“e-mail”) software system that enables users to create text and hypertext markup language (“HTML”) e-mail messages.

### BACKGROUND OF THE INVENTION

In the sales and marketing industries, the ability to send customized e-mail messages about goods and services, where the content of the e-mail is based on known data about an individual recipient, greatly enhances the chances that the individual will read the e-mail messages, and also enhances the chances that the individual will purchase the goods and services being advertised in the e-mail messages. If the e-mail messages sent by a company are not customized to a particular individual based on the individual's preferences or demographics, many individuals will simply delete the e-mail messages, and may even ignore future e-mail messages from the same company.

Despite the benefits of customizing sales and marketing e-mail messages, many companies send the same messages to each of their customers because it is currently extremely difficult to customize the messages in a timely and cost efficient manner. Currently, only two methods of customizing the content of marketing and sales e-mail messages are known. One such method engages a professional services firm to create the custom messages. In the second method, the company itself engages in highly technical custom programming to create custom messages.

Not only are these methods usually expensive and time consuming to utilize, these methods are also limited to the creation of separate e-mail documents for separate recipients. For example, an outdoor outfitter company may create one e-mail message for its customers in Alaska advertising the company's heavy jackets and boots, and then create a completely different separate e-mail message for its customers in Hawaii advertising the company's surfing gear. However, these methods do not allow for the creation of a single e-mail message for all of a company's customers wherein customized content can be interchanged within a single e-mail message based on information about the recipient. Instead, multiple separate e-mail messages must be created. Further, in many instances, the message conveyed in an e-mail message may be applicable to various types or classes of recipients, but it may be desired to deliver the message in a different form or with additional and/or different emphasis to various types or classes of recipients. For example, if an e-mail message is intended to convey the sale of a satellite radio and satellite radio service, the radio and service is something useful to persons of various ages and interests. However, to facilitate the sale of the radio and service, it may be desired to emphasize certain satellite radio stations to facilitate the sale for a particular age group. The present methods do not facilitate such customization of a particular e-mail document. Instead, not only would separate e-mail messages need to be created for the certain types of goods and services a company is advertising, but then the company would also need to create numerous separate e-mail messages to emphasize certain aspects of such goods and services based on information about the recipient, such as the age group.

Further, these separate e-mail messages often carry an executable file attachment so that the recipient must do more than simply open the e-mail message in order to view the customized content. The more steps that the recipient must take in order to view the customized content, the less likely that the recipient will view the content. Further, some recipients do not have the technological knowledge or equipment to open the executable file. Finally, today's virus protection systems often remove executable attachments automatically, thereby removing the tailored message.

For the foregoing reasons, it is desired to provide a system and method that allows non-technical users to easily and affordably deliver customized e-mail messages and promotions to e-mail recipients based on information about the recipients, such as the recipients' purchase history, age, income, and other demographic or interest data. In addition, it is desired that the e-mail messages are easily viewed by the recipient. It is further desired to provide a system and method that allows the e-mail sender to track the results of an e-mail campaign in order to determine the effectiveness of particular e-mail messages. It is still further desired to provide a system and method that allows the customization of a general e-mail document for various types or classes of recipients without highly technical programming skills on the part of the e-mail sender.

### SUMMARY

The present invention comprises a system for the creation and delivery of targeted electronic communications, including e-mail messages having dynamic content based on information about the recipients of the e-mail messages, and its method of use. Included in one embodiment of the system are a means for creating an e-mail message comprising at least one content area, wherein at least one of the at least one content area comprises a dynamic content area, a means for identifying a plurality of recipients, each of the plurality of recipients having at least one attribute associated therewith, a means for associating at least one of the at least one attribute with the dynamic content area, and a means for sending the e-mail message to the plurality of recipients. In one embodiment, the means for associating the at least one of the at least attribute with the dynamic area content comprises an if-then structure for interpretation of the sending system. In another embodiment, the at lest one attribute is selected from the group consisting of recipients' purchase history and preferences, age, income, geography, interests, and demographics.

In another embodiment of the system, the system includes a computing device having a database associated therewith, a first remote device in bidirectional communication with the computing device; at least one second remote device in bidirectional communication with the computing device, wherein the database comprises a plurality of e-mail addresses each for a plurality of recipients, each of the plurality of recipients having at least one attribute associated therewith, and the database comprises an e-mail document comprising at least one content area, wherein one of the at lest one content area is designated as dynamic, wherein the computing device accepts from the first remote device the e-mail document, the alternate contents for the dynamic content area, and the designated criteria based on a designated attribute that determines the applicability of the alternate contents, such that the computing device creates at least one e-mail message for transmission to those of the plurality of recipients at the at least one second remote devices whose attribute fulfills the designated criteria, the e-mail message containing the alternate content in the dynamic content area appropriate to the attribute.

In operation, a system user creates at least one general e-mail document designating at least one area of the general e-mail document dynamic. Thereafter, the system user creates dynamic content for inclusion into the at least one dynamic area of the e-mail document, the dynamic content varying depending upon one or more attributes associated with a plurality of recipients. The dynamic content is associated with at least one attribute, and is merged into the e-mail document in the at least one dynamic area of the e-mail document at the time the e-mail is sent. The merged e-mail document is sent to those of the at least one recipients having the at least one attribute. In one embodiment, the system user tracks the delivery and receipt of the sent merged e-mail document.

These and other advantages of the present invention, and the manner of attaining them, will be more apparent and better understood by reference to the following descriptions of the embodiments of the invention taken in conjunction with the accompanying drawings and with the appended claims.

### BRIEF DESCRIPTION OF THE DRAWINGS

FIG. 1 shows a block diagram of the components of one embodiment of the system of the present invention;

FIGS. 2A and 2B show screenshots providing an overview of one embodiment of the method of the present invention and providing further information about the method by textual explanation;

FIG. 3 shows a flow diagram illustrating one embodiment of the method of sending e-mail messages according to the present invention;

FIG. 4 shows a flow diagram illustrating method of formatting e-mail messages according to one embodiment of the present invention;

FIG. 5 shows a flow diagram illustrating one embodiment of the method by which an e-mail agent sends e-mail messages according to the present invention; and

FIGS. 6A, 6B, and 6C show examples of the extensible markup language (“XML”) format code generated to represent the if-then-else structure of dynamic content according to one embodiment of the present invention.

### DESCRIPTION OF THE INVENTION

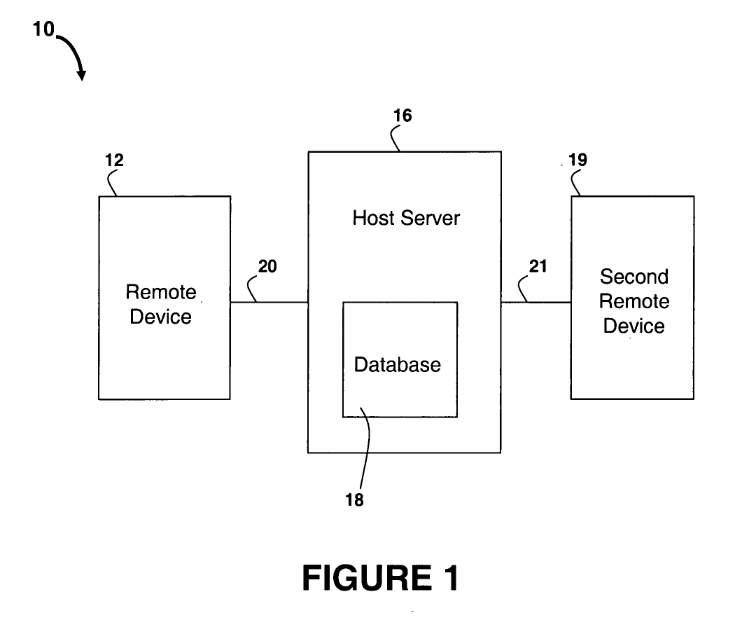

Referring now to FIG. 1, there is shown one embodiment of the components of the dynamic content e-mail marketing system according to the present invention. System 10 comprises first remote device 12, host server 16, database 18, second remote device 19, and computer networks 20 and 21. For purposes of clarity, only one first remote device 12 and second remote device 19 are shown in FIG. 1. However, it is within the scope of the present invention, and it will be appreciated by those of ordinary skill in the art, that the system of the present invention may have two or more first remote devices 12 and/or second remote devices 19 operating at the same time. In the embodiment shown in FIG. 1, first remote device 12 is operated by an e-mail sender and second remote device 19 is operated by an e-mail recipient. However, it is within the scope of the present invention, and will be appreciated by one of ordinary skill in the art, that system 10 may simply comprise a single remote device used by both the e-mail sender and the e-mail recipient.

First remote device 12 and second remote device 19 are computers, computing devices, or systems of a type well known in the art, such as a mainframe computer, workstation, personal computer, laptop computer, hand-held computer, cellular telephone, or personal digital assistant. First remote device 12 and second remote device 19 comprise such software, hardware, and componentry as would occur to one of skill in the art, such as, for example, one or more microprocessors, memory systems, input/output devices, device controllers, and the like. First remote device 12 and second remote device 19 also comprise one or more data entry means (not shown in FIG. 1) operable by users of first remote device 12 and second remote device 19 for data entry, such as, for example, a pointing device (such as a mouse), keyboard, touchscreen, microphone, voice recognition, and/or other data entry means known in the art. First remote device 12 and second remote device 19 also comprise a display means (not shown in FIG. 1) which may comprise many of the well known display means such as liquid crystal diode displays, light emitting diode displays, etc., upon which information may be displayed in a manner perceptible to the user.

Resident on, or accessible by, second remote device 19 operated by the e-mail recipient is a software means known in the art for retrieving e-mail messages from an e-mail mailbox including, but not limited to software means for viewing e-mail messages, for composing a response to an e-mail message, and for deleting an e-mail message.

Host server 16 comprises one or more server computers, computing devices, or systems of a type known in the art. Host server 16 further comprises such software, hardware, and componentry as would occur to one of skill in the art, such as, for example, microprocessors, memory systems, input/output devices, device controllers, display systems, and the like. Host server 16 may comprise one of many well known servers, such as, for example, IBM's AS/400 Server, IBM's AIX UNIX Server, or MICROSOFT's WINDOWS NT Server. In FIG. 1, host server 16 is shown and referred to herein as a single server. However, host server 16 may comprise a plurality of servers or other computing devices or systems interconnected by hardware and software systems know in the art which collectively are operable to perform the functions allocated to host server 16 in accordance with the present invention.

Database 18 is “associated with” host server 16. According to the present invention, database 18 is “associated with” host server 16 where, as shown in the embodiment in FIG. 1, database 18 resides on host server 16. Database 18 is also “associated with” host server 16 where database 18 resides on a server or computing device remote from host server 16, provided that the remote server or computing device is capable of bi-directional data transfer with host server 16. Preferably, the remote server or computing device upon which database 18 resides is electronically connected to host server 16 such that the remote server or computing device is capable of continuous bi-directional data transfer with host server 16.

For purposes of clarity, database 18 is shown in FIG. 1, and referred to herein as a single database. It will be appreciated by those of ordinary skill in the art that database 18 may comprise a plurality of databases connected by software systems of a type well known in the art, which collectively are operable to perform the functions delegated to database 18 according to the present invention. Database 18 may comprise a relational database architecture or other database architecture of a type known in the database art. Database 18 may comprise one of many well known database management systems, such as, for example, MICROSOFT's SQL Server, MICROSOFT's ACCESS, or IBM's DB2 database management systems, or the database management systems available from ORACLE or SYBASE. Database 18 retrievably stores information that is communicated to database 18 from first remote device 12 through computer network 20. In one embodiment, database 18 may also retrievably store information that is communicated to database 18 from second remote device 19 through computer network 21.

First remote device 12 communicates with host server 16 via computer network 20 and second remote device 19 communicates with host server 16 via computer network 21. For purposes of clarity, computer network 20 and computer network 21 are shown in FIG. 1 as distinct computer networks. However, computer networks 20 and 21 may comprise the same computer network. The communication between first remote device 12 and second remote device 19 and host server 16 may be bi-directional. Computer networks 20 and 21, or both, may comprise the Internet, but this is not required. Other networks, such as Ethernet networks, cable-based networks, and satellite communications networks, well known in the art, and/or any combination of networks are contemplated to be within the scope of the invention.

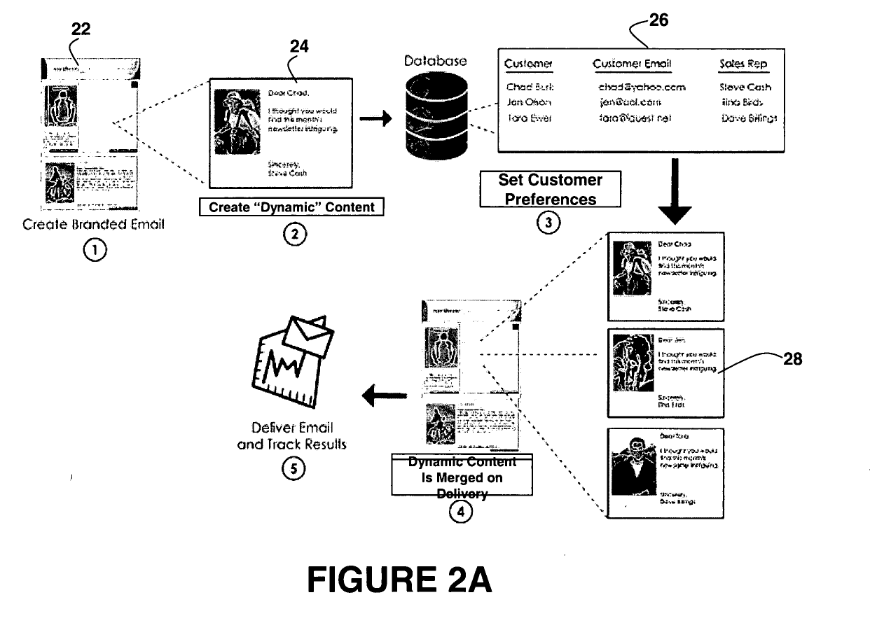

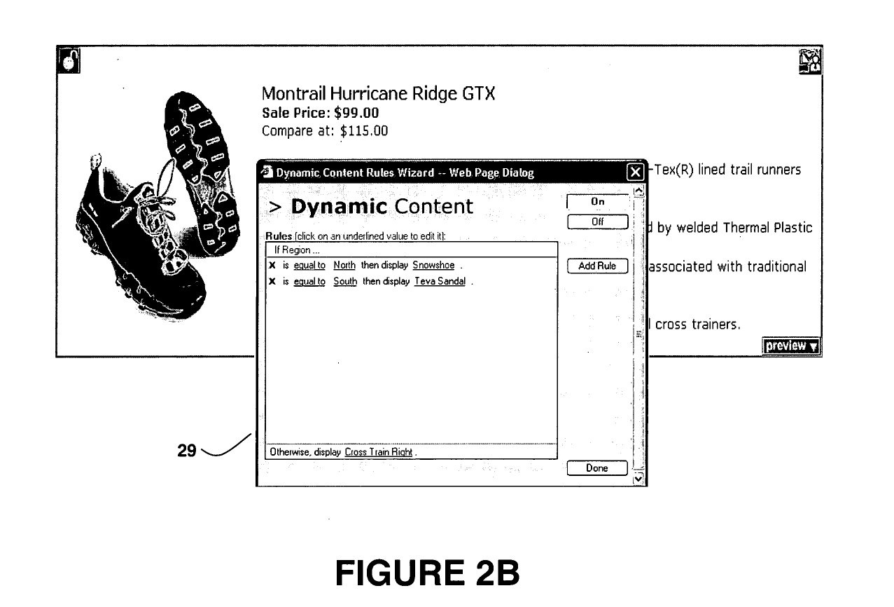

Briefly, as explained and illustrated in FIGS. 2A and 2B, in one embodiment of the present invention, the e-mail sender creates a generic e-mail message. The e-mail sender then designates one or more areas of the e-mail message as “dynamic,” meaning that such areas will subsequently be customized based on attributes about the e-mail recipient that the e-mail sender inputs as described in further detail below. The e-mailer sender then creates the customized content, or dynamic content, for the dynamic areas of the e-mail message. Thereafter, the e-mail sender creates a profile for each e-mail recipient by entering attributes about each e-mail recipient. For example, each e-mail recipient's profile may include a geographic region, such as north, south, east, or west, where the e-mail recipients reside. Once the e-mail sender completes the profile, the e-mail sender assigns the dynamic content to the areas of the generic e-mail message designated as dynamic based on elements of the e-mail recipient's profile. For example, if the e-mail recipient's geographical region in north, then the e-mail sender may assign a snowshoe as the dynamic content for the dynamic area of the e-mail message. When the e-mail sender sends the customized e-mail message to an e-mail recipient, system 10 inserts the dynamic content assigned by the e-mail sender into the e-mail message upon delivery of the e-mail message to the e-mail recipient. After the e-mail message is delivered to the e-mail recipient, the results of the e-mail campaign can be tracked by the e-mail sender.

More specifically, to operate system 10 according to the present invention, the e-mail sender enters into bi-directional communication with host server 16 via computer network 20 using first remote device 12. In one embodiment of the present invention, using the data entry means associated with first remote device 12, the e-mail sender enters into bi-directional communication from first remote device 12 to host server 16 via a specific uniform resource locator (“URL”) on the Internet. In this embodiment, first remove device 12 includes a browser, and after entering the URL on the address line of the browser, an introductory page is displayed on the display means of remote device 12.

In one embodiment of the present invention, after the e-mail sender selects the option of customizing the content of e-mail messages from the introductory page, the e-mail sender may be prompted to enter a valid passcode to access system 10 or to establish a valid passcode, as discussed below. The passcode is required to obtain use of system 10 appropriate for generation of the dynamic content e-mail message as described herein. An e-mail sender will apply for a valid passcode and a passcode will be assigned to the e-mail sender by means well known in the art. Using the data entry means of remote device 12, the e-mail sender enters his or her passcode. The e-mail sender will be allowed several attempts to correctly enter his or her valid passcode; however, if the e-mail sender repeatedly enters an invalid passcode, he or she will be instructed by system 10 to apply for a valid passcode. Acceptance of a valid passcode is achieved by means well known in the art.

After successfully entering a valid passcode, the e-mail sender is presented with the option of creating an e-mail message. FIG. 2A shows an exemplary e-mail message creation page 22. According to one embodiment of the present invention, using the data entry means, the e-mail sender first creates the elements of the e-mail message that will be the same, or generic, for all e-mail recipients. For example, the e-mail sender may input a company's logos and the company's contact information in certain areas of the e-mail message. The e-mail sender then designates areas of the e-mail message as dynamic. One area, multiple areas, or the entire e-mail message may be designated as dynamic.

After creating the generic e-mail message, the e-mail sender is presented with the option of creating the dynamic content for those areas of the e-mail message designated as dynamic. FIG. 2A shows an exemplary dynamic content page 24. Using the data entry means, the e-mail sender creates the dynamic content for the areas of the e-mail message that the e-mail sender designated as dynamic. The dynamic content may be created based on attributes of the e-mail recipients such as the e-mail recipients' purchase history and preferences, age, income, geography, interests, demographics, or other information about the e-mail recipients. As discussed above, dynamic content may be created based on the e-mail recipients' geographic location. For example, dynamic content may be created for an e-mail recipient based on whether the e-mail recipient resides in the north, south, east, or west regions of the United States of America. For a shoe company, the dynamic content for an e-mail recipient living in Alaska may relate to a snowshoe, while for an e-mail recipient living in Florida, the dynamic content may relate to a sandal. Additionally, default dynamic content may be created for e-mail recipients if an attribute of the e-mail recipient, such as the e-mail recipients' geographical location, is unknown. The dynamic content may include text, images, video, hyperlinks, etc., and may be stored in a content library in database 18 for easy management and reuse. Thereafter, the generic e-mail message and the dynamic content (which may include default dynamic content) to be inserted into the generic e-mail message is communicated via computer network 20 to host server 16 and stored in database 18.

After storing the generic message and the dynamic content in database 18, the e-mail sender is given the option of setting the profile for each e-mail recipient. FIG. 2A shows an exemplary profile page 26. For example, if an e-mail recipient is living in Alaska, the e-mail sender can set the e-mail recipient's geographic region as north. The e-mail recipient's profile determines the dynamic content that will be inserted into the generic e-mail message. The e-mail recipient's profile can be set using an interface according to one embodiment of the present system, or the profile can be imported from an external database belonging to the e-mail sender through means well known in the art. The e-mail recipient's profile is then communicated via computer network 20 to host server 16 and stored in database 18.

Thereafter, using the data entry means, the user assigns to those areas of the generic e-mail message designated as dynamic the dynamic content that will be inserted into the generic e-mail message based on the e-mail recipient's profile. FIG. 2A shows an exemplary assignment page 28. Using the previous example of geography, the e-mail sender can assign to an area of the generic e-mail message designated as dynamic the snowshoe dynamic content if the e-mail recipient's profile indicates that the e-mail recipient's geographic region is north, and can assign the sandal dynamic content if the e-mail recipient's profile indicates that the e-mail recipient's geographic region is south. Further, the e-mail sender can assign default content, such as a cross training shoe, which may be of interest to e-mail recipients in all geographical regions, if the e-mail recipients' geographic region is unknown. The e-mail sender can assign the content using a simple interface according to one embodiment of the present invention. FIG. 2B shows an exemplary interface page 29. This assignment is then communicated via computer network 20 to host server 16 and stored in database 18.

Thereafter, using the data entry means, the e-mail sender can choose to send the e-mail messages he or she created and customized to all e-mail recipients in the e-mail sender's mailing list for which the e-mail sender created a profile. The present system retrieves the e-mail messages from database 18, and the e-mail messages are sent to e-mail recipients via computer network 21 through means well known in the art. The dynamic content is inserted into the areas of the generic e-mail message designated as dynamic based on the assignments made by the e-mail sender at the time the e-mail message is delivered to the e-mail recipient. For example, if the e-mail sender assigned snowshoe content to an e-mail recipient because he or she resides in the north, the snowshoe dynamic content will be inserted into the area of the e-mail message designated as dynamic upon delivery of the e-mail message to the e-mail recipient.

To summarize the method of the present invention, as illustrated in FIG. 2A, e-mail messages having dynamic content are created, delivered, and optionally tracked according to the following steps. First, the general e-mail document is created, and certain areas of the general e-mail message are designated as dynamic so that customized content can be inserted into the areas of the general e-mail message designated as dynamic. Second, dynamic content is created for inclusion in the e-mail document. Third, customer preferences are established for the particular dynamic content to be provided based on the profile of the e-mail recipient. Fourth, according to the customer preferences, the dynamic content is merged with the general e-mail document. Fifth, the e-mail(s) are delivered to the various recipients. Finally, the results of the e-mail delivery, receipt, and other activities may optionally be tracked.

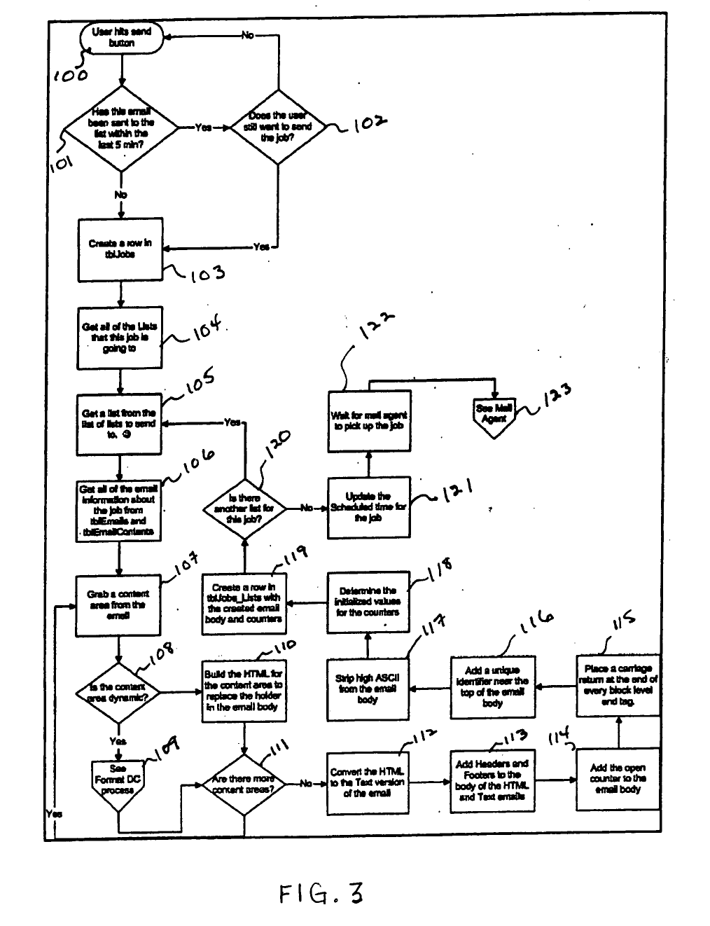

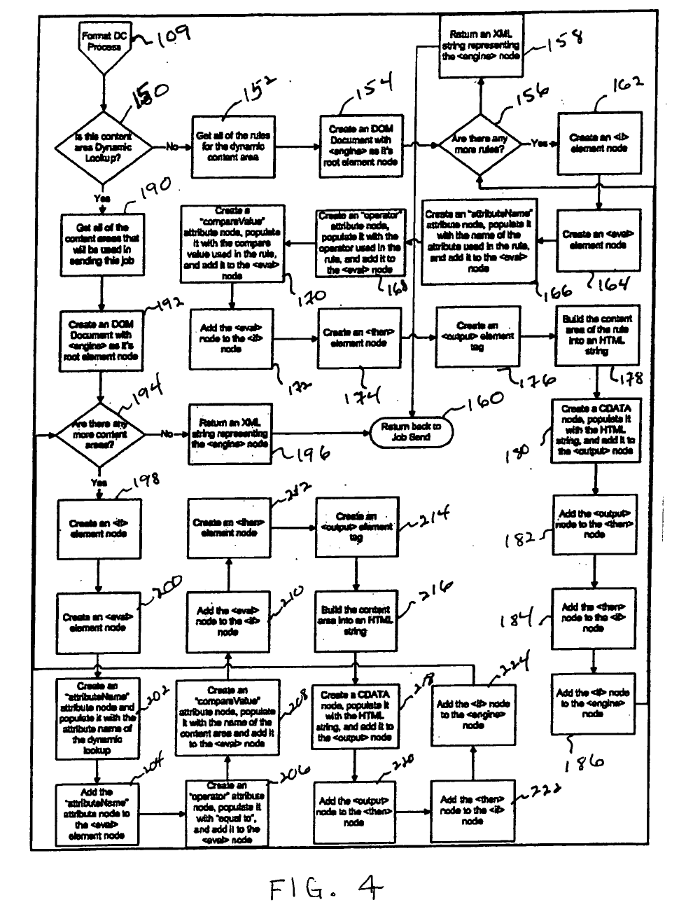

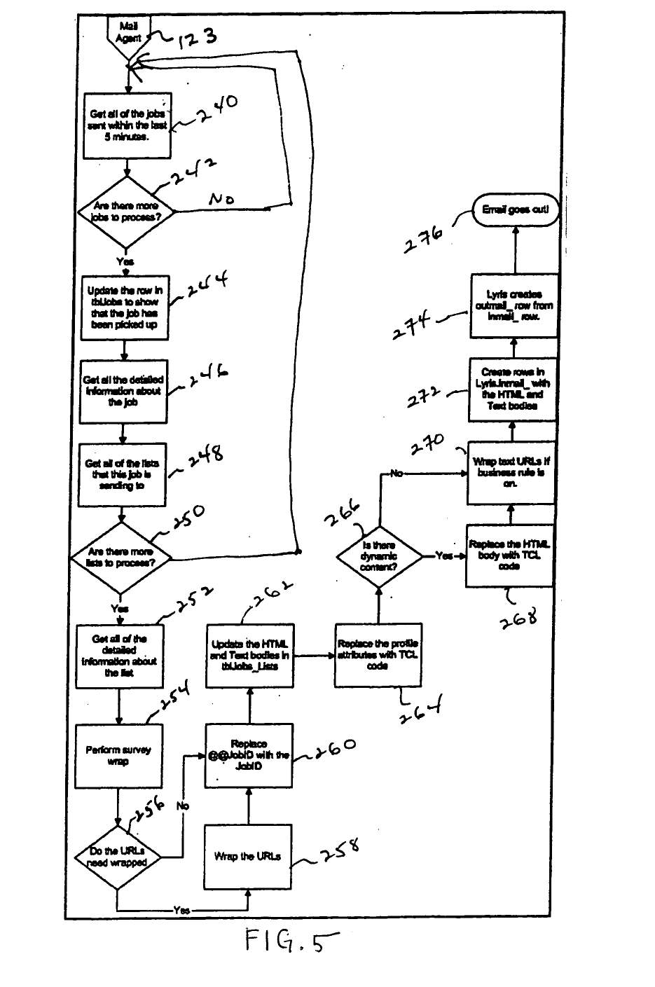

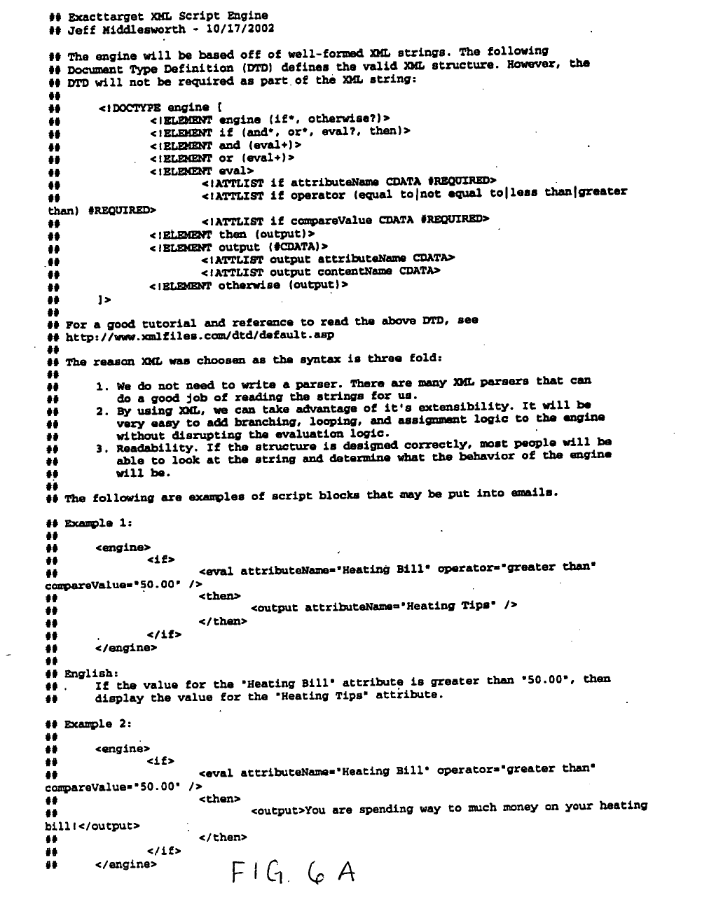

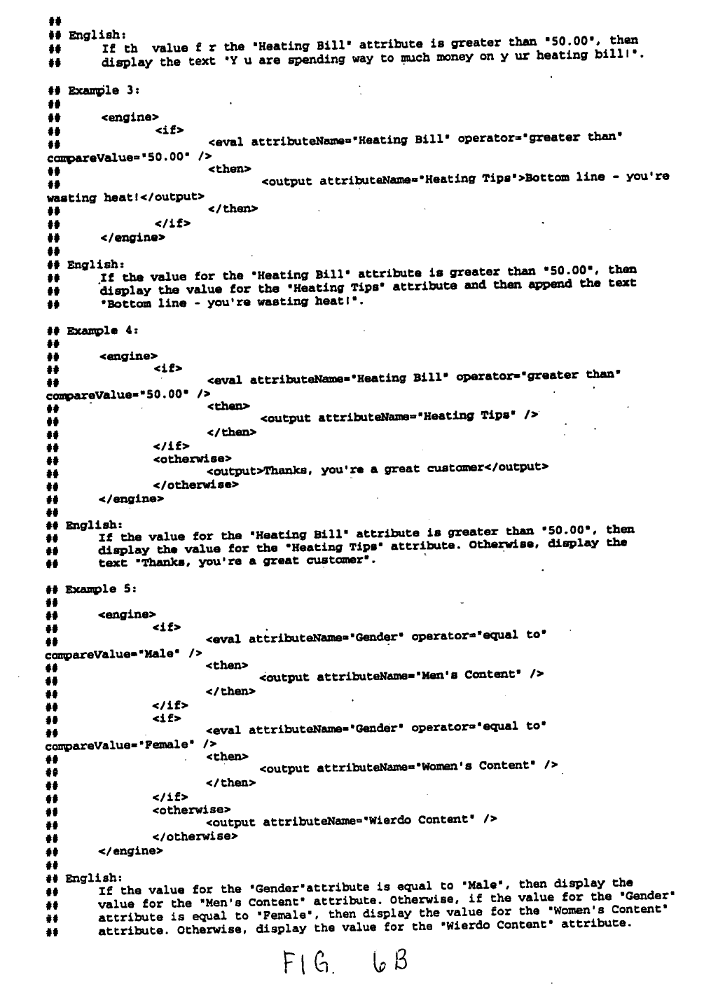

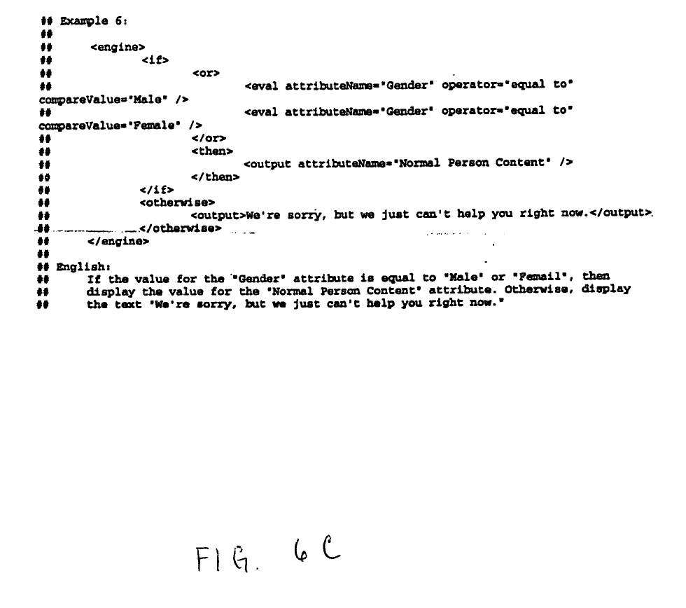

FIG. 3 shows a flow chart of one embodiment of the method by which the present system sends e-mail messages to e-mail recipients. Generally, the message is sent to those e-mail recipients on the e-mail sender's mailing list designated by the e-mail sender. If the e-mail message includes areas that are designated as dynamic, the dynamic content assigned to a particular area is inserted into the generic e-mail message by a method, one embodiment of which is shown in FIG. 4. As is well known in the art, the information contained in the e-mail message is displayed in HTML format, and the content is described in XML format. Examples of XML format for the if-then-else structure of dynamic content according to one embodiment of the present invention are shown in FIG. 6. After the dynamic content is inserted into the generic e-mail message through a method, one embodiment of which is shown in FIG. 4, the e-mail message is sent to the e-mail recipient via the e-mail agent according a method, one embodiment of which is shown in FIG. 5.

Referring now specifically to FIG. 3, one embodiment of the processes of creating e-mails having dynamic content is illustrated. At step 100, the user hits the “send” button using the data entry means on first remote device 12. At host server 16, in step 101, system 10 checks to see if the e-mail requested to be sent by the user has been sent in the last five minutes. If the e-mail has been sent in the last five minutes, host server 16 posts a message on first remote device 12 to inquire whether the sender wishes to send the job at step 102. If the user responds “No”, then host server 16 returns the user to the inquiry about whether to send an e-mail at step 100.

If host server 16 determines at step 101 that the e-mail has not been sent within the past five minutes or, if at step 102, the user indicates that he/she wishes to send the e-mail, system 10 proceeds to step 103. A row is created in tblJobs in database 18 at step 103. Then, in step 104, system 10 retrieves all of the Lists to which the job is to be sent. These “Lists” are one or more compilations of e-mail addresses to which the job is to be sent. At step 105, host server 16 retrieves one list of recipients from the Lists retrieved in step 104. In step 106, system 10 retrieves from database 18 the e-mail information about the job from tblEmails and tblEmailContents stored in database 18.

At step 107, host server 16 grabs a content area from the e-mail to be sent. Then, in step 108, host server 16 determines whether the content grabbed in step 107 is to be dynamic content. If the content is determined in step 108 to be dynamic, system 10 proceeds to step 109, the Format DC process, which is explained in further detail herein in FIG. 4. If the content is determined in step 108 not be by dynamic, system 10 proceeds to step 110. In step 110, host server 16 communicates with first remote device 12 to allow the user to build the non-dynamic content for that area of the e-mail. In this embodiment, the non-dynamic content is built using HTML code, for HTML code is the language used for Internet messages, and, in the embodiment where host server 16 and first remote device 12 communicate over the Internet, such language is a natural fit. However, this “natural fit” of the use of HTML code to build the non-dynamic content area is not a requirement under the present invention.

At the completion of either step 109 or 110, host server 16 determines at step 111 whether there are more content areas of the e-mail. These content areas may or may not be dynamic. Thus, if there are more content areas to the e-mail, host server 16 returns to step 107 to grab another contact area from the e-mail being generated for distribution.

Once all areas of content of the e-mail have been examined according to steps 107, 108, 109, 110, and 111, system 10 takes steps to prepare the e-mail to be sent. Such preparation includes collection of all the content areas—both dynamic content areas and non-dynamic content areas, and cleaning up of the e-mail. Such “cleaning” may involve stripping of unwanted characters and conversion to make the e-mail readable by the most common e-mails systems used by second remote device 19. Thus, in this embodiment, host server 16 proceeds to step 112 where the HTML code for content created in steps 109 and 110 is converted to a text version of the e-mail. The HTML version of the e-mail is converted to a text version of the e-mail for those e-mail recipients who are not able to view an HTML version of the e-mail. Both the HTML version and the text version of the e-mail is sent to the e-mail recipient (as described in more detail below), and generally the recipient's e-mail client (e.g., MICROSOFT® OUTLOOK®) determines which version to show to the recipient. The majority of e-mail recipients will view the HTML version of the e-mail message. In step 113, headers and footers are added to the body of the HTML and text e-mails For further processing of the e-mail, an open counter is added to the e-mail body in step 114 a carriage return is placed at the end of every block level and tag in step 115, and a unique identifier is added near the top of the e-mail body in step 116. All high ASCII code is then stripped from the e-mail body in step 117.

At step 118, host server 16 determines the initialized value for the counters. The counters store the total results from the e-mail (e.g., the number of e-mail recipients that viewed the e-mail) that can be viewed in the tracking reports. The tracking reports are discussed in more detail below. Counters generally fall into two categories. The first category of counters is snapshot counters that contain the initial total counts of subscribers, unsubscribed e-mail recipients, and undeliverable recipients on each e-mail list. The second category of counters is accumulators. Accumulators are initially set to zero and subsequently accumulate value as e-mail recipients open e-mails and click on links within the e-mail. Then, a row is created in tblJobs_Lists with the created e-mail body and counters in step 119. Host server 16 at step 120 then determines whether there are other lists, from the Lists originally identified in step 104, for this job. If there are additional lists, system 110 returns to step 105 to retrieve the next list. If there are no additional lists to be processed, system 10 continues to step 121. At step 121, host server 16 updates the scheduled time for the job. Then, at step 122, system 10 waits for mail agent 123 (see FIG. 5 for one embodiment of the mail agent of the present invention) to pick up the job for mailing.

It will be appreciated by those of skill in the art that many of the variables determined by system 10 or host server 16 as described above in association with FIG. 3 may request input from a use at first remote device 12. For example, the content areas, the Lists, time/date to send the job, etc. are generally data over which the user would like to control. Thus, by means well-known in the art, host server 16 in its bidirectional communication with first remote device 12 collects such information from the user setting up the job.

Referring now to FIG. 4, there is shown a flow chart of one embodiment of the process of formatting dynamic content according to the present invention. This formatting dynamic content process starts at step 109, illustrated in FIG. 3 and in this FIG. 4. As the first step in the formatting dynamic content process, host server 16 determines at step 150 whether or not the content area is a Dynamic Lookup area. As used herein, a “Dynamic Lookup area” means an area that has more than one type of content associated with it, and such content is stored in a location accessible by system 10. Thus, the correct content for a Dynamic Lookup area for a specific recipient must be “looked up” through the use of XML rules, which are discussed in more detail below. If this content area is not a Dynamic Lookup area, system 10 proceeds to step 152 at which all of the rules for the dynamic content area are “looked up” in database 18 via host server 16. These “rules” are written in an XML format and comprise a set of test conditions and a set of results. Host server 16 evaluates the test conditions for each e-mail recipient (for example, is the e-mail recipient's geographical region north?), and then determines the appropriate result (for example, if the e-mail recipient's geographical region is north, the result is to display a content area with snowshoes in the content area). From these rules, system 10 creates a Document Object Model (“DOM”) document with <engine> as its root element node is created at step 154. DOM documents are well known to those of ordinary skill in the art, while <engine> is a “tag” in an XML document. When a computer reads an XML document, it searches for these tags to interpret how to treat information contained in the document. The XML document described herein contains rules that must be evaluated to determine what content an e-mail recipient should receive, and the program that evaluates these rules is referred to as an “engine.” Thus, the XML document begins with the tag <engine> to indicate to the computer that the content of the XML document should be evaluated in accordance with the rules engine of system 10.

In further processing of a content area that is not a Dynamic Lookup area, at step 156 host server 16 determines whether there are more rules to apply to this dynamic content area. If it is determined at step 156 that there no more rules are to be applied, host server 16 returns an XML string representing the <engine> node at step 158 and returns back to the job send (to step [INSERT] of FIG. 3) at step 160.

If it is determined at step 156 that there are additional rules to be applied to that dynamic content area, host server 16 creates an <if> element node at step 162. This <if> element constitutes the beginning of a test condition and indicates that such test condition must be evaluated. To complete the <if> element, the if-then-else logic must be defined. This occurs in steps 164, 166, 168, 170, 172, 174, 176, 178, 180, 182, 184, and 186. Specifically, at step 164 host server 16 creates an <eval> element node for evaluating the <if> element. The <eval> node represents the—if-then-else structure to be used for this rule, as further described herein. At step 166, an “attributeName” attribute node is created, populated with the name of the attribute used in the rule, and added to the <eval> node. The attribute node represents the field to be compared in the if-then-else structure. In step 168, an “operator” attribute node is created, populated with the operator used in the rule, and added to the <eval> node. This “operator” is the Boolean operator to be used in the if-then-else condition. At step 170, a “compareValue” attribute node is created, populated with the compare value used in the rules, and added to the <eval> node. The “compareValue” is the value to be compare in the if-then-else structure.

At step 172, the <eval> node is added to the <if> node. The <then> element node is then created in step 174. In step 176, an <output> node element tag is created, and the—if-then-else structure is complete. Upon completion of this if-then-else structure, host server 16 proceeds to step 178 where the content area of the rules is built into an HTML string.

At step 180, a CDATA node is created, populated with the HTML string, and added to the <output> node. The <output> node is added to the <then> node in step 182, the <then> node is added to the <if> node in step 184, and the <if> node is added to the <engine> node in step 186. At the completion of step 186, the if-then-else structure has been completed and is associated with the rule. In terms of the nodes, the if-then-else structure is:

if (attribute node) (operator node) (compareValue node) then (output node) At the completion of step 186, host server 16 proceeds to step 156 to determined if there are more rules to be applied to this non-lookup dynamic content area. These rules may be saved in database 18 so that they can be reapplied to future communications.

Returning to step 150, if the content area comprises a Dynamic Lookup area, system 10 proceeds to step 190. At step 190, host server 16 gets all of the content areas that are to be used for this job. At step 192, a DOM document is created with <engine> as its root element node. At step 194, host server 16 determines whether there are more content areas that comprise the job. If the job does not comprise any additional content areas, an HTML string representing the <engine> element is returned in step 196, and the job is returned back to job send at step 160.

If, at step 194, host server 16 determines that the job comprises more content areas, host server proceeds to establish an if-then-else structure in a manner similar to the development of the if-then-else structure for the non-lookup dynamic content, except that in this case the “operator” is “equal to” [GARY, WHY IS THE OPERATOR “EQUAL TO”? Doreen: Still don't have this answer]. Specifically, at step 198, a <if> element node is created. At step 200, an <eval> element node is created. An “attributeName” attribute node is created and populated with the attributed name of the dynamic lookup in step 202. At step 204, the “attributeName” attribute node is added to the element node. An “operator” attribute node is created and populated with “equal to” and added to the <eval> node in step 206. In step 208, a “compareValue” attribute node is created, populated with the name of the content area, and added to the <eval> node. The <eval> node is added to the <if> node in step 210, a <then> element node is created in step 212, and an <output> node is created in step 214. At step 216, the content area is built into an HTML string. A CDATA node is created, populated with the HTML string created in step 216, and added to the <output> node in step 218. At step 22, the <output> node is added to the <then> node. The <then> node is added to the <if> node is step 222, and the <if> node is added to the <engine> node in step 224. At the completion of this representation of the if-then-else structure, host server 16 returns to step 194 to determine whether there are more content areas that comprise this job.

Referring now to FIG. 5, there is shown a flow chart of the mail agent process according to one embodiment of the present invention. According to this embodiment, mail agent 123 is the portion of the method of the present invention responsible for sending the appropriate e-mail to the appropriate recipients with the appropriate content as has been determined in the processes already discussed in association with FIGS. 3 and 4. At step 240, host server 240 retrieves all of the jobs requested to be sent in the last five minutes. If, at step 242, it is determined by host server 16 that there are more jobs to process, host server 16 proceeds to step 244 where the row in tblJobs is updated to show that the job has been “picked up” by the mail agent. In step 246, all detailed information about the job is retrieved from database 18, and all the lists for the job are retrieved in step 248.

At step 250, host server 16 determines whether there are more lists to be processed for that job. If no more lists are to be processed, the system returns to step 240. If there are lists to be processed, at step 252, all the detailed information about the list is retrieved from database 18 is retrieved. At step 254, a survey wrap is performed. System 10 comprises a survey library. Surveys created in the survey library can be included in e-mails. If a survey exists within the e-mail, it is located through this “wrap” process and modified so that links will operate correctly and can be subsequently tracked. In step 256, system 10 determines if the URLs need to be wrapped. E-mails may contain links entered by clients. The links to web pages are in the form of URLs. If an e-mail contains URLs, such URLs need to be located and modified so that the URLs can be properly tracked. This process is referred to herein as “wrapping.” If the URLs need to be wrapped, this is accomplished in step 258. System 10 then proceeds to step 260 where “@@JobID” is replaced with the JobID. JobID is a unique identification associated with each mailing. The JobID is utilized to assist in assigning e-mail opens and link clicking to the correct job for tracking. Thus, for every new mailing, system 10 creates a new JobID and replaces the text @@JobID found within the e-mail with the actual JobID for this job. Therefore, if the same e-mail is sent twice, the results may be tracked separately. At step 262, the HTML and text bodies in the tblJobs_Lists are updated. In step 264, the profile attributes are replaced with the TCL code.

Host server 16 determines if the job includes any dynamic content in step 266. If the job contains dynamic content, host server 16 replaces the HTML body the TCL code. System 10 then proceeds to step 270 where host server 16 wraps text URLs if the “business rule” for URL wrapping is on. As discussed above, e-mail senders can choose whether or not the sender desires for URLs located within their e-mails to be tracked. These URLs may be referred to as links. If the sender chooses to track links within their e-mails, during the send process, the links will be wrapped so that the links can be properly tracked. In one embodiment, e-mail senders record their preference as to whether to track the links using a checkbox that is made available to them when they login into system 10. This is referred to as a “business rule.” It is one of many options available with system 10 that allows e-mail senders flexibility to determine how their account will operate. Collectively, these options are referred to as “business rules.”

At step 272, rows in Lyris inmail_are created with the HTML and text modes. At step 274, Lyris creates outmail_row from inmail_row. Lyris is a mail agent. However, in other embodiments of the present invention, other mail agents may be utilized to send e-mails. The inmail table contains request to send an e-mail, and is evaluated by the mail agent. When a new job is found, it is transferred to the outmail table where the send is managed by the mail agent. Finally, the mail agent sends e-mails for the specified e-mail list in step 276.

The logic illustrated in FIG. 3, FIG. 4, and FIG. 5 may be amended to accomplish the same result. Such amendments are of the type well-known to one skilled in the art and are contemplated to be within the scope of the invention. It will be appreciated by those of skill in the art that the fields “tblJobs”, “tblEmails”, “tblEmailContents”, and “tblJobs_Lists” are representative of tables stored in database 18 and are not intended to be limiting. Other field designations and record types well-known in the art are contemplated to be within the scope of the present invention. Further, the representation of the if-then-else structure shown in FIG. 4 may be achieved by other mechanism well-known in the art.

Referring now to FIG. 6, there are shown examples of XML code generated and used by the method of the present invention. These example are representative of the if-then-else structure used for dynamic content according to one embodiment of the present invention. Shown in FIG. 6 is the document type definition for <engine>, and examples written in XML code with the affect of the samples explained in English. XML code was selected as the syntax for the if-then-else structure for the following reasons: (1) parsers for XML code are generally available; (2) XML is advantageous in its extensibility—it is easy to add branching, looping, and assignment logic to the <engine> without disrupting the evaluation logic; and (3) XML is very readable—the average person can look at the string and determine the meaning and affect of the <engine>.

Yet another feature of the present invention is that users can track information about e-mail messages sent according to the present invention and the actions that the e-mail recipients take with respect to the e-mail messages that the e-mail recipient received.

In one embodiment, the user can view three types of tracking information, namely e-mail message summary information, e-mail message delivery information, and e-mail links information. E-mail summary information may include, but is not limited to the name of a particular e-mail message, the subject of the e-mail message, the date and time the e-mail message was delivered, and the name of the e-mail recipient list to whom to e-mail message was directed. E-mail message delivery information may include, but is not limited to a delivery summary and forward to a friend summary.

The information set forth in the delivery summary may be expressed in terms of numbers and percentages. This information includes, but is not limited to the number and percentage of e-mail recipients to whom a particular e-mail message was sent, the number and percentage of such e-mail messages that were undeliverable, the number and percentage of the e-mail messages that were delivered to e-mail recipients, the number and percentage of replies to the e-mail messages stating that the e-mail recipient desired to “unsubscribe” to such e-mail messages, the number and percentage of e-mail messages that were opened by the e-mail recipient, and the number and percentage e-mail recipients that selected a hyperlink that was included in the e-mail message in order to view the material hyperlinked to the e-mail message (a “click-through”). By selecting the number of e-mail messages that were opened by an e-mail recipient, the e-mail sender is shown the name of e-mail recipients that opened the e-mail message and the time that the message was opened. Similarly, by selecting the number of click-throughs, the e-mail sender is shown the name of the e-mail recipients that clicked-through the message and the time at which the click-through occurred.

Delivery information may also include forward to friend information. Forward to friend information may include, but is not limited to the number and percentage of e-mail messages that were forwarded by the original e-mail recipient to a new e-mail recipient, the number and percentage of new e-mail recipients that received the e-mail message, and the number and percentage of new e-mail recipients that desire to subscribe to system 10 as a result of the forwarded e-mail message.

It will be appreciated by those of skill in the art that the system and method of the present invention provides marketers with a great deal of flexibility in the type of information to be conveyed by electronic mail to its recipients. A general e-mail document can be tailored for various types of recipients by use of the dynamic content feature. The e-mails generated are developed according to content areas. One or more of those contents areas may be variable (dynamic) and presented to recipients based on information or the classification of that recipient. Essentially, from a single general e-mail, several alternatives are created and sent to recipients.

It will be further appreciated that the system and method of the present invention generates e-mail messages readable by various types and brands of e-mails systems. The use of HTML and text in the e-mail messages make this advantage so. The file sent to the recipient, in most instances, does not contain any executable file requiring that the recipient have a specific program on the second remote device 19 to execute the transmitted file.

While the present invention has been described in considerable detail with reference to certain exemplary embodiments thereof, such description is offered by way of a non-limiting example of the present invention as many other versions of the present invention are possible. It is anticipated that a variety of modifications and changes will be apparent to those having ordinary skill in the art and that such modifications and changes are intended to be encompassed within the spirit and scope of the present invention as defined by any later appended claims.

I claim:

1. A system, comprising:
means for creating an e-mail message, the e-mail message comprising at least one content area, and wherein at least one of the at least one content area comprises a dynamic content area;
means for identifying a plurality of recipients, each of the plurality of recipients having at least one attribute associated therewith;
means for associating at least one of the at least one attribute with the dynamic content area; and
means for sending the e-mail message to the plurality of recipients.

2. The system of claim 1, wherein the means for associating at least one of the at least one attribute with the dynamic content area comprises an if-then-else structure for interpretation by the system.

3. A system for creating targeted e-mail messages, the system comprising:
means for creating an e-mail message, the e-mail message comprising a plurality of content areas, and wherein at least one of the plurality of content areas comprises a dynamic content area;
means for identifying a plurality of recipients, each of the plurality of recipients having at least one attribute associated therewith;
means for creating customized content wherein the customized content is dependent on the at least one attribute;
means for associating the at least one attribute with the at least one dynamic content area;
means for merging the customized content into the at least one dynamic content area; and
means for sending the e-mail message to the plurality of recipients.

4. The system of claim 3, wherein the means for associating the at least one attribute with the at least one dynamic content area comprises an if-then-else structure for interpretation by the system.

5. The system of claim 3, wherein the at least one attribute is selected from the group consisting of the plurality of recipients' purchase history and preferences, age, income, geography, interests, and demographics.

6. The system of claim 3, further comprising:
means for creating default content if the at least one attribute of any of the plurality of recipients is unknown; and
means for merging the default content into the at least one dynamic content area.

7. The system of claim 3, further comprising a means for tracking the delivery and receipt of the sent e-mail message.

8. The system of claim 3, wherein the customized content contains at least one type of content selected from the group consisting of text, images, video, and hyperlinks.

9. A system, comprising:
a computing device having a database associated therewith, wherein the database comprises a plurality of e-mail addresses each for a plurality of recipients, each of the plurality of recipients having at least one attribute associated therewith;
a first remote device in bidirectional communication with the computing device;
at least one second remote device in bidirectional communication with the computing device;
wherein the computing device accepts from the first remote device: (i) an e-mail document comprising at least one content area, wherein one of the at least one content area is designated as dynamic, (ii) alternate contents for the dynamic content area dependent on the at least one attribute associated with each of the plurality of recipients, and (iii) designated criteria based on an attribute designated from the at least one attribute that determines the applicability of the alternate contents, such that the computing device creates at least one e-mail message for transmission to those of the plurality of recipients at the at least one second remote device whose designated attribute fulfills the designated criteria, the e-mail message containing the alternate content in the dynamic content area appropriate to the designated attribute.

10. The system of claim 9, wherein the at least one attribute is selected from the group consisting of the plurality of recipients' purchase history and preferences, age, income, geography, interests, and demographics.

11. The system of claim 9, wherein the alternate contents contains at least one type of content selected from the group consisting of text, images, video, and hyperlinks.

12. A method for creating targeted e-mail messages, the method comprising the steps of:
creating at least one general e-mail document;
designating at least one area of the general e-mail document as a dynamic area;
creating dynamic content for inclusion into the dynamic area of the e-mail document, the dynamic content varying depending upon at least one attribute associated with a plurality of recipients;
associating the dynamic content with the at least one attribute;
merging into the e-mail document the dynamic content in the dynamic area of the e-mail document; and
sending the merged e-mail document to those of the at least one recipients having the at least one attribute.

13. The method of claim 12, further comprising the step of:
tracking the delivery and receipt of the sent merged e-mail document.

14. The method of claim 12, further comprising the steps of:
creating default content of interest to all of the plurality of recipients; and
merging into the e-mail document the default content in the dynamic area of the e-mail document if the at least one attribute is unknown.

15. The method of claim 12, characterized in that the dynamic content is of a type selected from the group consisting of text, images, video and hyperlinks.

16. The method of claim 12, characterized in that the at least one attribute is selected from the group consisting of the plurality of recipients' purchase history and preferences, age, income, geography, interests, and demographics.
